(19) United States
(12) Patent Application Publication
(10) Pub. No.: US 2007/0122529 A1
(43) Pub. Date: May 31, 2007

(54) FRUIT SPONGE

(75) Inventors: Huy Lam THAI, Edmonton, AB (CA); Valerie Grace PRICE, Edmonton, AB (CA); Saul KATZ, Edmonton, AB (CA)

Correspondence Address: EDWARD YOO C/O BENNETT JONES, 1000 ATCO CENTRE, 10035 - 105 STREET, EDMONTON, ALBERTA, AB, T5J3T2, CA

(73) Assignee: ADVANCED NUTRI-TECH SYSTEMS INC., Edmonton (CA)

(21) Appl. No.: 11/610,922

(22) Filed: Dec. 14, 2006

Related U.S. Application Data
(63) Continuation-in-part of application No. 10/604,841, filed on Aug. 21, 2003.

(51) Int. Cl. A23B 7/16

(52) U.S. Cl. 426/102

(57) ABSTRACT

A low density food bar includes dried fruit pieces and a binder to produce a sponge-like consistency.

### CROSS REFERENCE TO RELATED APPLICATIONS

This application is a continuation-in-part of U.S. patent application Ser. No. 10/604,841 filed on Aug. 21, 2003 entitled “Fruit Sponge”, the contents of which are incorporated herein by reference.

### FIELD OF THE INVENTION

The present invention relates to a low-density fruit bar having a spongy consistency.

### BACKGROUND

Bar products have been a growing trend in the market place for a number of years. They satisfy a need for convenient nutrition for a lifestyle that does not allow enough time for traditional meal preparation. In the past few years, more bars have become available that address specific nutritional concerns on an age, gender and need segmented basis. In North America, it has been documented that children do not consume enough fibre and one of the primary sources of fibre in the diet is fruit. In addition, their diets tend to be higher in fat than the World Health Organization recommends.

The textural aspects of a snack food bar are important determinants of their acceptance by consumers. Typically snack food bars can be grainy and dry (typical granola texture), dense and smooth (protein bar texture), crunchy and light (rice crispy bars), sticky and chewy (fruit leathers). The desired nutritional profile and ingredients used to achieve that are the primary determinants of the textural qualities of a bar. Protein bar and rice crispy bar technology have been documented in the patent literature. They teach or reiterate techniques that one skilled in the art is reasonably familiar with. Some of this knowledge has been held as trade secrets and over time, other food scientists have been able to duplicate the products on their own. The number of reasonably successful bars on the market in all of these categories bears witness to the common knowledge held by skilled people.

The techniques used to manufacture snack bars have also become common knowledge to those skilled in the art and large equipment companies produce standard equipment that is capable of making the fruit snack bars described here-in. Descriptions of various parts of the process are found in the patent literature.

Fruit-based bars are typically dense and sticky and are very high in sugar content with low nutritional value.

### SUMMARY OF THE INVENTION

A bar of the present invention uses low moisture fruit to provide fibre and preferably supplements the nutrient balance with whey protein. This provides a superior nutrient mix to fruit leather bars. It is a healthy alternative to chocolate bars and other high fat, high sodium snack products typically used in children's lunches.

In one aspect and in general terms, the present invention comprises a food bar comprising:
(a) fruit component comprising dried fruit pieces, flakes or powders; and
(b) a binder;
   wherein said food bar has a density of not more than about 1.1 g/cm3 and a hardness rating of not more than 2.0 kg and a moisture content of between about 15% to about 30%.

### DETAILED DESCRIPTION OF PREFERRED EMBODIMENTS

The present invention provides for a low-density, spongy fruit bar. When describing the present invention, all terms not defined herein have their common art-recognized meanings. The term “bar” refers to a food bar in a single-serving size of any shape including a traditional rectangular or elongate shape. Therefore, a bar of the present invention may include, without limitation, any three-dimensional shape including balls, elongated rolls, irregular forms such as stylised or animated characters, fruit-shaped forms or extruded forms. Preferred shapes may include those that are preferred by children.

The invention provides compositions and methods for producing a fruit snack bar with a unique texture. The texture can be described as moist, spongy, soft and chewy, pliant. It is reminiscent of a sponge. In one embodiment the primary contributor to the texture is the low moisture fruit component. That texture may be enhanced by a binding system that has a soft “melt in our mouth”, marshmallow like texture.

Shelf-stability of the product is inclusive of the preservation of the color, texture, flavor and microbiological cleanliness of the finished product. In some cases the fruit pieces are treated with sulfite salts to preserve the color as is well-known in the art. These products have a slightly higher moisture content as the sulfites have the added advantage of preventing microbial growth. Since sulfites can, in rare cases, produce allergic reaction, an iteration of the product was invented that does not use artificial preservatives but relies on lower moisture content of the original fruit ingredients for preservation. The texture is slightly different, being somewhat less soft and slightly chewier. The water activity of the fruit pieces and of the mass is designed in a range that prevents the growth of molds, yeasts and bacteria.

Overall, the moisture content of the product is higher than conventional fruit-based products, which tend to be have low-moisture content to aid in stability and resistance to spoilage. Low moisture content however is not conducive to the spongy texture of the present invention. In one embodiment, the moisture content of bars of the present invention is between about 15% to about 30%, and preferably between about 20% to about 25%.

A shelf life of 6-12 months in room temperature storage is anticipated for this product when packaged in the appropriate barrier packaging. In general terms this would be a metallized polypropylene heat sealed around the individual bar.

The processing of the bar can be done in one of three ways. These are extrusion, cold slab formation and marshmallow/rice crisp process. All of these processes are well known in the industry.

Characterization of Ingredients

1. Fruit Pieces

Evaporated apples (also called “regular moisture” and “dried”) are prepared from sound, properly ripened fruit which has been washed, peeled and cored, sorted, trimmed, cut into approximately 0.25 inch cubes (6 mm×6 mm×6 mm). The apple pieces are properly dried to a range of 22-26% moisture by weight (unsulfured product in a range of 16-18%).

The product is inspected throughout the process to assure a clean, wholesome product which is in complete compliance with the provisions of the Federal Food, Drug and Cosmetic Act, as well as European Union and other international food laws and regulations.

The apple pieces may be primarily Delicious, Granny Smith and other peeler varieties (Fuji, Galas, etc.), however, the variety of apple is not a limitation of the present invention. Indeed, the present invention is not limited to the use of dried apple pieces. Other dried fruits such as peaches, pears, plums, bananas, may also be suitable.

Natural product (uncultured) treated with natural flavors and colors such as, but not limited to, sour apple and blueberry. Sulfured apples may be treated with either natural and/or artificial flavours and colours such as, but not limited to, cherry, peach and strawberry.

The term “sulfured” refers to the process of treating the diced apples with sulfur dioxide which preserves color and prevents microbial growth.

Alternatively, low moisture fruit flake powder may be combined with fruit pastes or purees to provide the fruit component while maintaining moisture levels in the product.

2. Binder Systems

The syrup binder used to hold the fruit pieces together may include Fruitrim, Energy Smart, corn syrup, high fructose corn syrup, or rice syrup. Typically these syrups have a DE (dextrose equivalent) in the range of 45 to 70 and total solid content between 65 and 80%. The binding capacity of the syrups may be enhanced by including minor amounts of carbohydrate products such as oats and inulin.

In alternative embodiments, a syrup binder may not be necessary, or may be minimized if a fruit puree or fruit paste is used in the formulation.

In a preferred embodiment, the bar is supplemented with a high-quality protein source such as whey protein isolate or concentrate with no less than 80% protein by weight. Particle size will be US standard sieve No. 40. Lactose will be about 3%, Moisture-5% fat 2% and Ash 3.5%. The flavour will be clean and bland; the colour white to light cream.

In a preferred embodiment, the bar may be supplemented with a dietary fibre source such as inulin. Inulin is an all natural functional food ingredient, providing 100% soluble dietary fibre. It is prepared by novel processes of extraction and purification from the chicory root and analytically certified for nutritional applications. It is further processed to optimize its solubility, dispersion and flow. It is a white, neutral and slightly sweet powder. The total carbohydrate content is 95% with inulin/FOS at 90%±2.2. Ash is about 0.10%. Moisture is about 5%. The modal chain length is 9 monomer units. DP (degree of polymerization—chain length) range is 2-50.

The bar may be coated for aesthetic reasons and enhanced taste. If applied, the coating may be a commercial white chocolate or yogurt confectioner's coating. Typically they will have a melting point of about 91° F. and a fat content of about 28%.

Other minor ingredients which add to the flavour, nutritional and/or organoleptic properties of the bar may include:
(a) Canola oil;
(b) Flavors—dependant on the flavor of the bar. May be natural for the unsulfated bars and natural and/or artificial for the sulfated bar;
(c) Citric Acid—USP grade;
(d) Water;
(e) Rolled Oats—Instantized;
(f) Vitamin and Mineral Premix and other supplements such as Ambrotose may be added.

### EXAMPLES

The following examples are exemplary of the claimed invention but are not intended to be limiting thereof.

### Example 1

### Sulfured Fruit

Apple Dices 54.5%

Fruitrim 17.1%

90% Whey Protein Isolate 9.4%

Inulin IQ 4.9%

White Confectioners Coating 4.5%

Water 2.8%

Rolled Oats—instantized 2.3%

Flavor 2.3%

Canola Oil 1.9%

Citric Acid 0.3%

### Example 2

### Unsulfured Fruit

Apple Dices 59.4%

Rice Syrup 15.3%

90% Whey Protein Isolate 8.4%

Inulin IQ 4.3%

White Confectioners Coating 4.0%

Water 2.5%

Flavor 2.1%

Rolled Oats—instantized 2.0%

Canola Oil 1.7%

Citric Acid 0.3%

### Example 3

### With Vitamin and Mineral Premix

Apple Dices 54.1%

Fruitrim 17.0%

90% Whey Protein Isolate 7.5%

Vitamin/Mineral Premix 6.6%

White Confectioners Coating 4.4%

Water 2.8%

Flavor 2.3%

Rolled Oats—instantized 2.0%

Canola Oil 1.9%

Inulin IQ 0.7%

0.3%
   Citric Acid

### Example 4

### Fruit Puree and Fruit Paste

Low moisture Apple Flake Powder 6.11%

Low moisture Pear Flake Powder 4.81%

Hi-Maize 240 Fiber (Resistant starch) 4.96%

Low moisture Banana Flake Powder 9.54%

Evaporated Apple Chip ⅛″ NO S0222.91%

Pear Paste 20.83%

Plum/date/grape fruit puree 28.07%

Sunflower Oil High Oleic 1.53%

Nat. Cherry Flavor WONF 0.24%

Natural Red Color 0.99%

Nutrient Composition

A typical bar weighs 50 grams although versions intended for children may be smaller. The general nutrient composition of the 50 gram unfortified bar is as follows:

Total Calories 150

Total Fat 2 grams

Total Cholesterol 0 grams

Sodium 100 mg

Total Carbohydrate 32 grams

Fibre 4 grams

Protein 5 grams

Water 11 grams

The fortified bar has about 30% of vitamins and minerals for which there is an established daily value.

A 100 g product of Example 4 has the following nutritional composition:

Calories 310.48

Calories from Fat 19.4

Calories from Saturated Fat 2.87

Protein 1.62 g

Carbohydrates 73.25 g

Dietary Fiber 10.51 g

Soluble Fiber 0.73 g

Insoluble Fiber 1.01 g

Sugar—Total 53.11 g

Fat—Total 2.16 g

Saturated Fat 0.32 g

Cholesterol 0.28 mg

Water 21.4 g

Ash 1.67 g

Density and Harshness

The bars of the present invention have as a distinguishing feature being a spongy, light texture. This feature may be measured by objectively measuring the hardness of the bar and its density. Hardness rating of the bar is defined as the force (kgf) necessary to compress a bar having a thickness of about 20 mm, 6 mm using a flat circular probe having a 12 mm diameter.

Bars of the present invention may have a hardness rating of not more than about 1.5 kgf and preferably between about 0.9 kgf to about 1.1 kgf. Hardness ratings higher than about 1.5 kgf may not have the preferred “spongy” texture.

Bars of the present invention are preferably less dense than the density of the dried fruit pieces which comprise the bar. Therefore, in a preferred embodiment, the bars may have a density of between about 0.6 g/cm³ to about 1.1 g/cm³. More preferably, the bars will have a density between about 0.8 g/cm³ to about 0.9 g/cm³.

Process

Physical Properties of the Mass

In order to process the food mass into a shaped bar product, the ingredients, excluding the fruit and coating, must be an appropriate mix of hydratable carbohydrates (starch, sugar and fiber) and proteins to form a mass with sufficient cohesion to bind and hold the larger discrete particles of fruit. While there is some flexibility in the ratio of fluids and solids, this part of the formulation is critical to the remaining steps in the process.

Method 1 and 2

In the first two methods, the wet ingredients are mixed together and the citric acid added to that mix. These ingredients are not heated but mixed at ambient room temperature. The ingredients are blended until the citric acid is dissolved and a smooth consistency is reached. The dry ingredients are blended separately until they are evenly mixed. The dry ingredient blend is added to the wet ingredients and mixed until a consistent mass is formed. The mass adheres to itself and does not stick to the sides if the bowl. It is a soft dough like mass that can be easily manipulated and may slump but does not flow. The forming, coating (enrobing) and packaging of nutrition bars is a well understood technology with several companies producing high quality equipment designed specifically to cold extrude or slab form bars. Patents exist that describe the process in detail. U.S. Pat. No. 5,776,887 describes this process with references to similar patents. The composition of this bar is unique but the attributes of the food mass that make it machinable are similar to the attributes of food bars that are currently formed on production equipment. Those attributes are stickiness, density, flowability. (may be more here) The distinction between methods 1 and 2 comes after the mixing step. The extrusion method (method 1) forces the food mass through a die onto a moving conveyor belt so the height and width are determined by the size of the extrusion die. The “ropes” of extruded product are cooled and cut to length by a guillotine style cutter. The slab former method (method 2) compresses the mass into a large slab of even thickness between two large rollers that are typically temperature controlled. The temperature can be controlled to help the mass release from the rollers. Circular knives are used to cut the bars to width. A spreading conveyor separates the bar “ropes” and feeds them in to the same guillotine cutter that is used in the extrusion technique.

This bar may be fully enrobed but using typical enrobing equipment, however, the formulation anticipates that the product will have a pattern of drizzled confectioners coating laid down by conventional means. This coating material functions only to change the organoleptic qualities and does not play a role in the preservation of the shelf life of the product.

Method 3

An alternate method of mixing this bar is using the traditional method for making rice crisp bars. Marshmallow candy technology is used to produce a syrup which has air injected into it. The fruit pieces are then incorporated and formed similarly to making rice crisp squares. It is this mixing step that makes Method 3 distinct from Methods 1 and 2. Again this technology is well understood and production equipment available to produce bars in this manner. This method is described in U.S. Pat. No. 4,039,688 with references to other patents on the same subject.

The enrobing comments apply to this technique as well.

As will be apparent to those skilled in the art, various modifications, adaptations and variations of the foregoing specific disclosure can be made without departing from the scope of the invention claimed herein. Variations may include the use of other low moisture fruits and vegetables, other binding systems and other minor ingredients. The various features and elements of the described invention may be combined in a manner different from the combinations described or claimed herein, without departing from the scope of the invention.

What is claimed is:

1. A food bar comprising:
(a) fruit component comprising dried fruit pieces, flakes or powders; and
(b) a binder;
wherein said food bar has a density of not more than about 1.1 g/cm3 and a hardness rating of not more than 2.0 kg and a moisture content of between about 15% to about 30%.

2. The food bar of claim 1 wherein the fruit pieces comprise unsulfured dried apple pieces having a moisture content of about 16% to about 18%.

3. The food bar of claim 1 wherein the fruit pieces comprises sulfured dried apple pieces having a moisture content of about 22% to about 26%.

4. The food bar of claim 1 wherein the food bar has a density of not more than about 0.85 g/cm³.

5. The food bar of claim 1 wherein the food bar has a hardness rating of not more than 1.5 kg.

6. The food bar of claim 5 wherein the food bar has a hardness rating of about 0.9 kg to about 1.1 kg.

7. The food bar of claim 1 further comprising a protein source.

8. The food bar of claim 7 wherein the protein source comprises whey protein.

9. The food bar of claim 1 further comprising a source of dietary fibre.

10. The food bar of claim 9 wherein the dietary fibre comprises inulin.

11. The food bar of claim 1 wherein the binder comprises a syrup, fruit puree or fruit paste.

12. The food bar of claim 1 having a moisture content of between 20% and 25%.
